(19) United States
(12) Patent Application Publication
(10) Pub. No.: US 2025/0344856 A1
(43) Pub. Date: Nov. 13, 2025

(54) Furniture with Integrated LED Lighting

(71) Applicant: Alexander Petruzzelli, Miami Lakes, FL (US)

(72) Inventor: Alexander Petruzzelli, Miami Lakes, FL (US)

(21) Appl. No.: 18/660,075

(22) Filed: May 9, 2024

(51) Int. Cl. A47B 97/00; F21S 4/28; F21V 21/08; F21V 23/04; F21V 33/00; F21W 131/301; F21Y 103/10; F21Y 115/10

(52) U.S. Cl. CPC A47B 97/00; A47B 79/00; F21V 21/0808; F21V 23/04; F21V 33/0012; A47B 2220/0077; F21S 4/28; F21W 2131/301; F21Y 2103/10; F21Y 2115/10

(57) ABSTRACT

An article of furniture having an LED strip light integrated therein to provide both illumination and a specific design element to the article of furniture. In the preferred embodiment, the article of furniture comprises a plurality of drawers and the LED strip light is affixed to a recessed front edge of the top panel of the article of furniture. In a preferred embodiment, the LED strip light is connected to an on/off switch disposed in a rear corner of the top panel of the article of furniture with the connecting electrical wire hidden from view.

### FIELD OF INVENTION

The present invention relates to an article of furniture having an LED lighting feature integrated therein. More particularly, the present subject matter relates to an article of furniture having a plurality of drawers and an integrated LED lighting feature incorporated along a recessed edge of the top panel of the article of furniture.

### BACKGROUND OF THE INVENTION

Illuminated furniture such as glass display cases, cabinet and shelving systems with recessed lighting and the like are well known in the art. Typically, the illumination source has not been integrated within the article of furniture in such a manner that is aesthetically pleasing. Rather, functionality has been the primary purpose of securing a lighting feature to a furniture item, oftentimes distracting from the lines and design of the article of furniture.

### PRIOR ART

U.S. Patent 2015/0300627 A1 to Wang et al. discloses an LED lighting arrangement which can be embedded in the non-utilizing surface of an article of furniture in order to hide the LED lighting arrangement. The LED lighting provides an optimal light for decorating and illuminating functions and includes a battery compartment for powering the lighting arrangement. U.S. Pat. No. 9,612,006 B2 to Powell et al. discloses a table having integrated lighting including at least one light-diffusing insert mounted along at least a portion of a side edge. Neither Wang et al. or Powell et al. teach the integration of an LED lighting strip to provide illumination and to add a specific design element for an article of furniture.

### SUMMARY OF THE INVENTION

The present subject matter relates to an article of furniture having an LED lighting feature integrated therein to provide both illumination and a specific design element to the article of furniture. More particularly, the present subject matter relates to an article of furniture having a plurality of drawers and an integrated LED lighting strip which is disposed along a recessed edge of the top panel of the article of furniture. An off/on switch is provided on the top panel, preferably located in a corner of the top panel distal to the recessed edge.

Accordingly, it is an object of the present subject matter to provide an article of furniture having an LED lighting strip integrated therein.

It is another object of the present subject matter to provide an article of furniture having a plurality of drawings and an LED lighting strip affixed to a front recessed edge of the top panel of the article of furniture.

It is yet another object of the present subject matter to an article of furniture having an LED lighting strip integrated therein which enhances the aesthetic design of the article of furniture.

It is a further object of the present subject matter to provide an article of furniture having an integrated LED lighting strip which provides illumination to the user.

It is an additional object of the present subject matter to provide an article of furniture having an integrated LED lighting strip connected to an on/off switch by an LED light cord, the on/off switch being disposed in a corner of the rear edge of the top panel distal from the recessed front edge.

It is still another object of the present subject matter to provide an article of furniture having an integrated LED lighting strip and an on/off switch which is connected by a switch cord to a power supply.

It is a yet another object of the present subject wherein the article of furniture which has an integrated LED lighting strip is a bedroom dresser, a bedroom nightstand or end table.

These and other objects of the present subject matter are accomplished by providing an article of furniture comprising a plurality of drawers and a top panel having a recessed front edge and affixing an LED lighting strip within the recessed front edge and above the uppermost of the plurality of drawers in such a manner to provide both illumination and an aesthetically appealing design element.

### BRIEF DESCRIPTION OF DRAWINGS

FIG. 1 is a front perspective view of an article of furniture of the present subject matter having a plurality of drawers and an integrated LED strip light affixed to the recessed front edge of the top panel above the uppermost drawer.

FIG. 2 is a front perspective view of an article of furniture illustrating the integration of the LED strip light.

FIG. 3 is an exploded top perspective view of the integration of the LED strip light to the article of furniture of the present subject matter.

FIG. 4 is an exploded side view of an article of furniture of the present subject matter depicting the integration of the LED strip light and a hidden LED light cord connected to the LED strip light.

FIG. 5 is an exploded top perspective of an article of furniture of the present subject matter depicting the electrical connection means of the LED strip light to an on/off switch and power supply.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

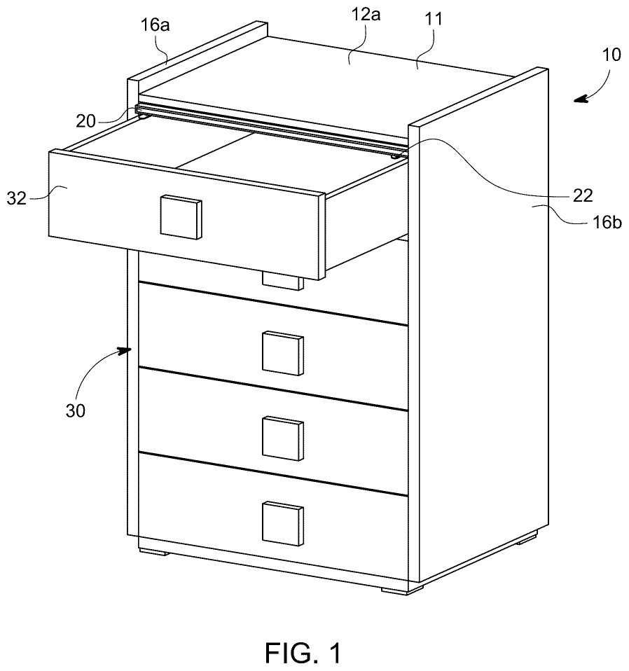

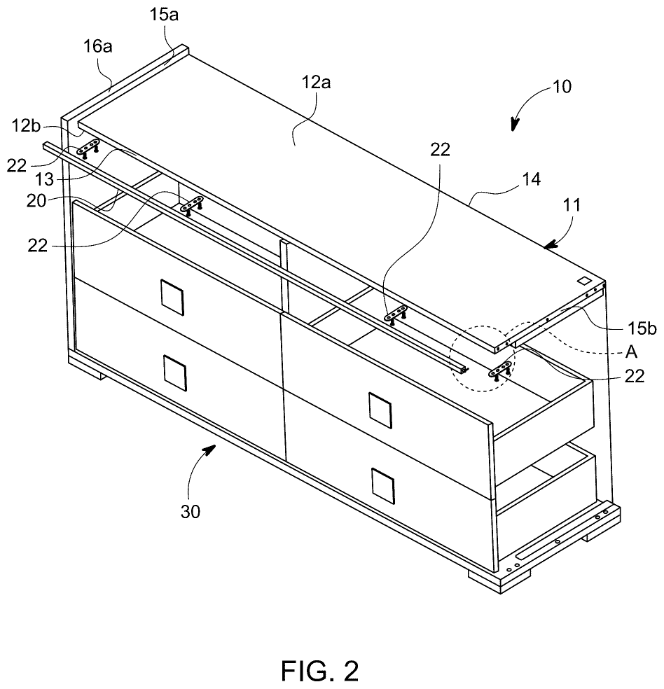

The present subject matter relates to an article of furniture having an LED lighting strip integrated within the upper front portion of the furniture. Referring now to FIGS. 1 and 2, an article of furniture, generally denoted 10 is shown comprising a top panel 11 having an upper surface 12A and an under surface 12B, a front recessed edge 13, a rear edge 14 and side edges 15A and 15B. The article of furniture further comprises two opposing side panels 16A and 16B, a rear panel 17, a front portion 30 having a plurality of drawers 31 with at least one uppermost drawer 32 having a front top edge 33. The width of the top panel 11 is less than the width of the two opposing side panels 16A and 16B, thereby creating the front recessed edge 13. This difference in width is sufficient to affix an LED strip light 20 is along the length front recessed edge 13 in such a manner that it does not extend beyond the opposing side walls 16A and 16B. The LED strip light 20 has about the same height as the recessed front edge such that it is disposed above the top front edge 19 of the uppermost drawer 31. It will be obvious to those skilled in the art that there may be two or more uppermost drawers depending upon the design of the article of furniture. FIG. 1 illustrates a chest of drawers having single uppermost drawer 32 and FIG. 2 illustrates a dresser which would have two uppermost drawers. Of course, it is contemplated to be within the scope of the present invention that the article of furniture may have three uppermost drawers, four uppermost drawers or more than four uppermost drawers.

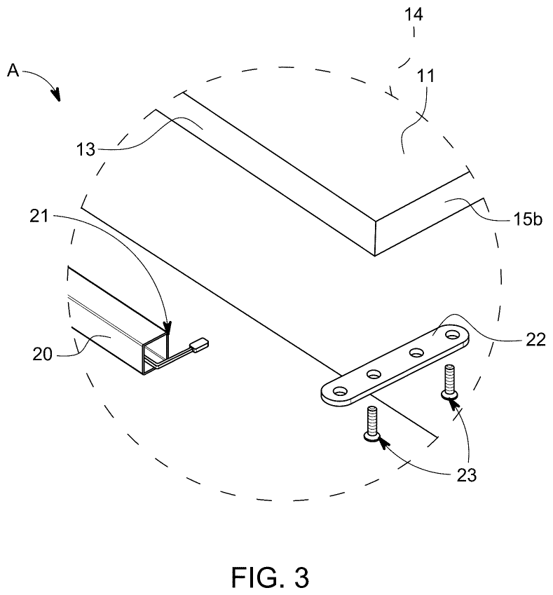

Referring now to FIGS. 2 and 3, the LED strip light 20 can be secured or affixed to the recessed front edge 13 in any manner as will be obvious to those skilled in the art. In a preferred embodiment, the LED strip light 20 is affixed to the recessed front edge by a double-sided adhesive tape 21. Integration of the LED strip light 20 can be strengthened by means of a plurality of support elements 22, such as metallic supports, that are affixed to the under surface 12B of the top panel 11 in such a manner that a portion of the support element of about the same length as the width of the LED strip light extends outward from the under surface and the LED strip light 20 is supported thereon. In a preferred embodiment, the plurality of support elements 22 are affixed to the under surface 12B by screw means 23. In one embodiment, at least two support elements 22 are utilized, one at each end of the recessed front edge 13. In a preferred embodiment as illustrated in FIG. 2, four support elements 22 are utilized, two support elements, one at each end and two support elements, one each disposed above the mid portion 34 of an uppermost drawer 32.

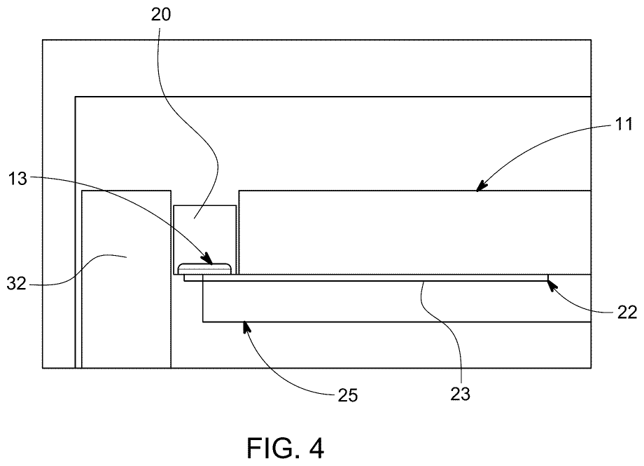

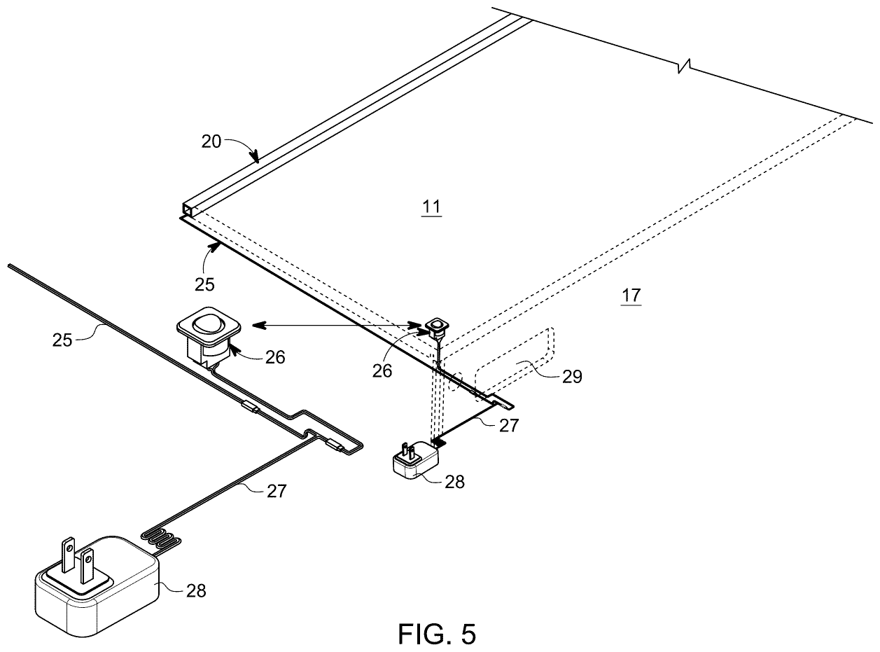

Referring now to FIG. 4 and FIG. 5, the integrated LED strip light 20 is connected at one end 24 an LED light cord 25, such as standard electrical wiring, which traverses the under surface 12B along the side panel 16B and is connected to an on/off switch 26 which is disposed in the top panel 11 in the corner adjacent side panel 16B and rear panel 17. A switch cord 27 extends through an opening 29 disposed in the rear panel 17 and is electrically connected to a power supply 28. With this design configuration, the LED light cord and the switch cord both are hidden from view to maintain the aesthetic appeal of the article of furniture of the present subject matter.

As discussed previously, the article of furniture of the present subject matter can comprise any plurality of drawers disposed within the front portion such that the LED strip is integrated above the uppermost drawer and along the recessed front edge of the top panel of the article of furniture. Suitable articles of furniture for use with the subject matter of the present invention, include for example, a bedroom dresser, a chest of drawers, bedroom night stand and an end table.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. An article of furniture comprising
a. a top panel having an upper surface and an under surface, said top panel having a recessed front edge;
b. a front portion having a plurality of drawings with at least one uppermost drawer, said at least one uppermost drawer having a front top edge;
c. two opposing side panels, each of said two opposing side panels having a width slightly greater than said top panel in such a manner to form said recessed front edge; and
d. a rear panel having an opening disposed therein;
wherein an LED strip light is integrated within said article of furniture by affixing said LED strip light along the length of the recessed front edge in such a manner that said LED strip light does not extend beyond said opposing side walls and is disposed above said front top edge of said at least one uppermost drawer, and wherein said LED strip light has a first end and a second end, said first end being connected to a first electrical wire which traverses said under surface of said top panel and is connected to a switch means disposed in said top panel in the corner adjacent one of said opposing side panels and said rear panel, said switch means being connected to a power supply by a second electrical wire.

2. The article of furniture in accordance with claim 1, wherein said LED strip light is affixed to said recessed front edge by means of a double-sided adhesive tape.

3. The article of furniture in accordance with claim 2, wherein a plurality of support elements is affixed to said under surface of said top panel by screw means in such a manner that a portion of each of said plurality of support elements having about the same width as said LED strip light extends outwardly from said under surface and said LED strip light is supported on said portion.

4. The article of furniture in accordance with claim 3, wherein said plurality of support elements is two support elements, disposed at opposing ends of said recessed front edge.

5. The article of furniture in accordance with claim 3 wherein said plurality of support elements includes two support elements disposed at opposing ends of said recessed front edge and additional support elements, each of said additional support elements being equal in number to the number of said at least one uppermost drawer and disposed at a midway point above said at least one uppermost drawer.

6. The article of furniture in accordance with claim 5 comprising one uppermost drawer, wherein said plurality of support elements is three support elements, two support elements disposed at opposing ends of said recessed front edge and the third support element disposed at a midway point above said one uppermost drawer.

7. The article of furniture in accordance with claim 5 comprising two uppermost drawers, wherein said plurality of support elements is four support elements, two support elements disposed at opposing ends of said recessed front edge, a third support element disposed at a midway point above a first of said two uppermost drawers and a second support element disposed at a midway point above a second of said two uppermost drawers.

8. The article of furniture in accordance with claim 3, wherein said plurality of support elements is in the form of metallic support elements.

9. The article of furniture in accordance with claim 1, wherein said article of furniture is a bedroom dresser having two uppermost drawers.

10. The article of furniture in accordance with claim 1, wherein said article of furniture is a bedroom chest of drawers having one uppermost drawer.

11. The article of furniture in accordance with claim 1, wherein said article of furniture is a bedroom night stand.
